(19) United States
(12) Patent Application Publication
(10) Pub. No.: US 2014/0183011 A1
(43) Pub. Date: Jul. 3, 2014

(54) SWITCH DEVICE

(71) Applicants: HYUNDAI MOTOR COMPANY, Seoul (KR); KIA MOTORS CORPORATION, Seoul (KR)

(72) Inventors: June Kyu Park, Hwaseong (KR); Yong Soo Chang, Seoul (KR); Hyun Kim, Yongin (KR); Bock Cheol Lee, Suwon (KR)

(73) Assignees: KIA MOTORS CORPORATION, Seoul (KR); HYUNDAI MOTOR COMPANY, Seoul (KR)

(21) Appl. No.: 13/873,651

(22) Filed: Apr. 30, 2013

(30) Foreign Application Priority Data
Dec. 27, 2012 (KR) 10-2012-0154466

(51) Int. Cl. H01H 25/00

(52) U.S. Cl. CPC H01H 25/008
USPC 200/4

(57) ABSTRACT

A switch device including: a circuit board, a mounting member, a push button and a rotary knob. The circuit board includes a switch, and the mounting member has a vertical slit and is fixed on the circuit board. The push button is inserted in the mounting member, is vertically guided along the slit, and when moved downward presses the switch. Additionally, the push button has a guide groove along the outer circumference. The rotary knob encloses the outer circumference of the push button, has a locking portion on an inner side which is inserted into the guide groove of the push button, and rotates independently from the push button but vertically moving with the push button while moving vertically.

### CROSS-REFERENCE TO RELATED APPLICATION

This application claims under 35 U.S.C. §119(a) the benefit of Korean Patent Application No. 10-2012-0154466 filed on Dec. 27, 2012, the entire contents of which are incorporated herein by reference.

### BACKGROUND

(a) Technical Field

The present invention relates to a switch device that allows operating and stopping functions by pushing after selecting the functions through turning.

(b) Background Art

As vehicles have become equipped with various devices for convenience and stability for a driver, operation switches for operating the devices are being mounted in the vehicles to control these devices. As a result the number of buttons for operating various functions of the devices are increasing as well.

In general, an operation switch is disposed at a side of or under a steering wheel and a light is installed to the operation switch to provide visibility and ease of operation to a driver in a dark environment such as during night driving. However, with the increase of the functions of vehicles, there is limitations in the space for the layout of buttons corresponding to each function according to the increase of the operation switches. Furthermore, the switches must be arranged differently for each device specification to prevent incorrect operation of the operation switches.

Although an integrated switch has been previously mounted on the steering wheel, the display indicating the multiple functions of the switch is separated from switch and is often disposed on the cluster or in other devices, therefore the driver has to view a cluster display when checking whether the corresponding operation is performed/selected, after operating the operation switch. In addition, this technology has another problem in that there is a significant cost associated with its implementation. Thus it is often applied only to expensive vehicles with a large LCD cluster.

Therefore, it is necessary to develop a switch that can be used in reduced mounting space in a vehicle by reducing the size of an operation switch while providing convenience to a driver by supporting various functions operable with simple operations and a low cost structure.

The description provided above as a related art of the present invention is just for helping understanding the background of the present invention and should not be construed as being included in the related art known by those skilled in the art.

### SUMMARY OF THE DISCLOSURE

The present invention has been made in an effort to solve the above problems and an object of the present invention is to provide a switch device that can reduce the amount of space required for mounting an operation switch, avoid complicated operation of buttons even with various functions, and provide convenience to a driver by supporting various functions that may be selectively performed with simple operations while providing a cost efficient structure.

In order to achieve the objects of the present invention, a switch device includes: a circuit board with a switch; a mounting member fixed on the circuit board and having a vertical slit; a push button inserted in mounting member, vertically guided along the slit, pressing the switch when moving downward, and having a guide groove along the outer circumference; and a rotary knob enclosing the outer circumference of the push button, having a locking portion on the inner side which is inserted in the guide groove, rotating independently from the push button, and vertically moving while the push button is vertically moving.

A display unit may be provided on the top surface of the push button showing various functions and whether a selected operation is performed. A plurality of light-emitting parts corresponding to display of functions of the display unit may be formed on the circuit board as well.

The push button may be a hollow part and a plurality of separations vertically formed and dividing the portions showing the functions of the display unit may be formed in the push button. A sensor may be configured to detect a selected position in accordance with the rotation of the knob and may be disposed on the mounting member or the rotary knob.

A position display unit rotating with the rotation of the rotary knob may be formed at the upper end of the rotary knob. The position display unit may be implemented by a light-emitting device that lights a position selected in accordance with the rotation of the rotary knob.

A support portion facing the lower end of the rotary knob may be formed on the outer circumference of the mounting member, so that the push button and the rotary knob are restrained from moving down beyond a certain point.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a perspective view showing a switch device according to an exemplary embodiment of the present invention;

FIG. 2 is an assembly view showing the switch device shown in FIG. 1;

FIG. 3 is an assembly cross-sectional view showing the switch device shown in FIG. 1; and

FIG. 4 is a view showing the operation of the switch device of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

A switch device according to exemplary embodiments of the present invention is described hereafter with reference to the accompanying drawings.

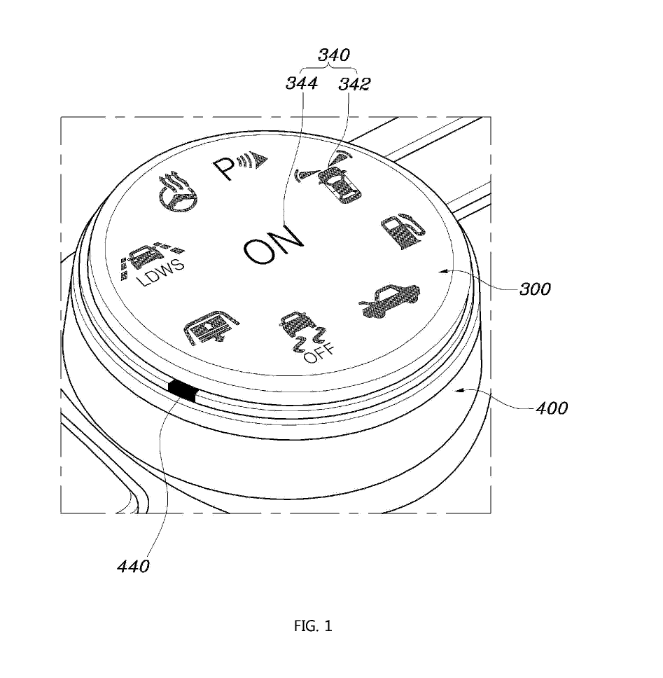

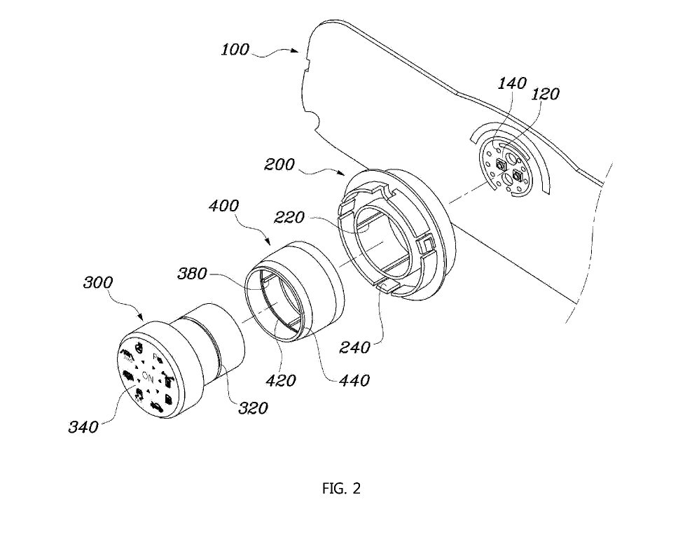

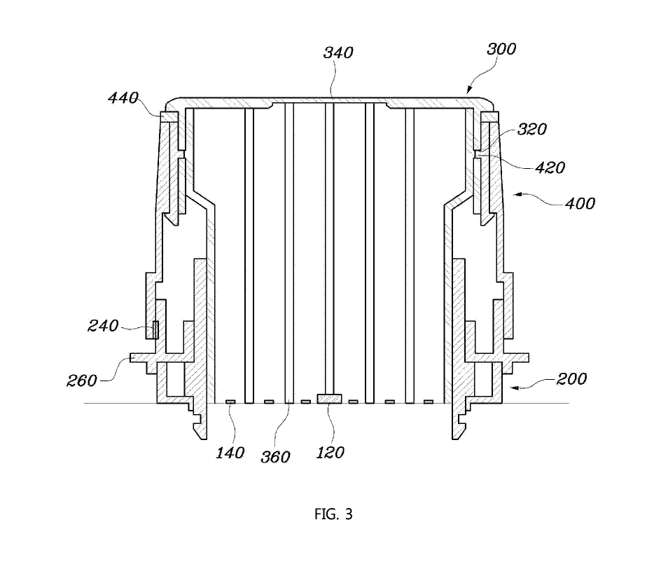

FIG. 1 is a perspective view showing a switch device according to an exemplary embodiment of the present invention, FIG. 2 is an assembly view showing the switch device shown in FIG. 1, and FIG. 3 is an assembly cross-sectional view showing the switch device shown in FIG. 1.

A switch device of the present invention includes: a circuit board 100 with a switch 120, a mounting member 200 fixed on the circuit board 100 and having a vertical slit 220; a push button 300 inserted in mounting member 200, vertically guided through the slit 220, pressing the switch 120 when moved downward, and having a guide groove along the outer circumference; and a rotary knob 400 enclosing the outer circumference of the push button 300, having a locking portion 420 on the inner side which is inserted in the guide groove 320, rotating independently from the push button 300, and vertically moving while the push button 300 is vertically moving.

The present invention is composed of the mounting member 200 fixed on the circuit board 100, the push button 300 vertically moving on the mounting member 200, and the rotary knob 400 assembled to rotate outside the push button 300, so that a desired function may be selected by rotating the rotary knob 400 during operation of the present invention and then the function may be performed by means of the push button 300.

Describing the present invention specifically, the mounting member 200 serves as a bracket fixed to the circuit board 100 and the slit 220 is formed inside, so that the push button 300 may be guided to slide up/down along the slit 220. Further, rotation of the push button 300 can be prevented by connecting the push button 300 to the slit 220 formed at the mounting member 200.

The push button 300 coupled to the mounting member 200 has a flange 380 inserted in the slit 220 of the mounting member 200 and the flange is formed at the position corresponding to the switch 120 on the circuit board 100 to be able to press the switch 120 disposed on the circuit board 100 when moving downward. The switch 120 disposed on the circuit board 100 receives a support force from an elastic or biasing force, so that it can return the push button 300 that has moved downward to its static position so that the push button 300 may prepare the next operation. Further, since the guide groove 320 is formed along the outer circumference of the push button 300, the push button 300 is coupled to the rotary knob 400, to be described below.

The locking portion 420 is held in the guide groove 320 of the push button 300 and the rotary knob 400 encloses the outer circumference of the push button 300. The push button 300 of the present invention is moved only up/down by operation of a driver, whereas the rotary knob 400 can rotate in addition to moving up/down with the push button 300.

As shown in FIG. 3, the push button 300 and the rotary knob 400 are coupled by the guide groove 320 and the locking portion 420. In detail, the push button 300 is coupled to the mounting member and moves only up/down. Since the rotary knob 400 is coupled to the push button 300 by the locking portion 420 held in the guide groove formed along the outer circumference of the push button, the rotary knob moves up/down with the up/down movement of the push button 300. Further, the locking portion 420 of the rotary knob 400 crosses the guide groove 320 of the push button 300, so that the rotary knob 400 can rotate along the outer circumference of the push button 300, with the push button 300 restricted in rotation.

The present invention can be implemented even if the forming positions of the guide groove 320 of the push button 300 and the locking portion 420 of the rotary knob 400 are removed from those described above, and the present invention may be implemented by disposing a separate locking member with the guide groove 320 or the locking portion 420 between the push button 300 and the rotary knob 400. The present invention described above may be used in various ways, since it is possible to integrally form the push button 300 and the rotary knob 400 and to allow the rotary knob 400 to independently rotate along the outer circumference of the push button 300 in addition to up/down movement of the rotary knob 400 with the push button 300.

A display unit 340 showing function indicators 342 and whether an operation is performed may be formed on the top of the push button 300 and a plurality of light-emitting parts 140 corresponding to the function indicators 342 of the display unit 340 may be formed on the circuit board 100. Further, the push button 300 may be a hollow part and a plurality of separations 360 vertically formed and dividing the portions showing the functions of the display unit 340 may be formed in the push button.

Recently, with the increase of the functions for convenience of a driver in a vehicle, switch buttons for operating various functions such as an air-conditioning system, auto-drive, opening/closing a trunk, and a front-facing camera are increasing. According to the present invention, it is possible to display the various functions on the top of the push button 300, select desired functions by rotating the rotary knob 400, and operate/stop the selected functions by operating the push button 300. That is, the display unit 340 composed of the function indicators 342 for the functions and a work indicator 344 showing whether an operation is performed is disposed on the top of the push button 300 so that the driver can recognize a desired function at a glance. As shown in FIG. 1, the ON/OFF work indicator 344 showing whether an operation is performed is disposed at the center of the push button 300 and the various function indicators 342 are arranged around the work indicator 344. It is preferable that the function indicators 342 are implemented by icons from which the driver can easily recognize corresponding functions.

The display unit 340 on the push button 300 should be clearly visible to the driver, so the light-emitting parts 140 corresponding to the display of functions and work of the display unit 340 may be formed on the circuit board 100. Since the push button 300 is a hollow part and the separations 360 vertically formed to divide the parts displaying the functions of the display unit 340 are formed in the push button, the light-emitting parts 140 corresponding to the functions are restrained to light the parts displaying other functions, thereby turning on/off the display of the functions.

More specifically, as the push button 300 moves up/down and presses the switch 120, the light-emitting parts 140 turn on the corresponding functions through the display unit 340 of the push button 300 to allow the driver to recognize that the corresponding functions are being performed. However, the function display of the display unit 340 is performed such that the driver can recognize it by turning on/off the icons while the work display shows whether the corresponding functions are being performed is indicated by ON/OFF so that the drive can easily identify their selections. To this end, the light-emitting parts 140 showing whether an operation is performed can display whether the function is ON/OFF through a specific display device and the display device is well known in the art, so the detailed description is not provided. However, it may be possible to display a work by turning on/off an ON-state in order to reduce the manufacturing cost and simplify the structure of the present invention.

When the light-emitting parts 140 disposed on the circuit board 100 to correspond to the functions turn on/off other functions due to dispersion of light, the driver may make a mistake while operating the switch, so that the separations 360 are vertically disposed to divide the display parts of the functions of the display unit 340 in the push button 300. Accordingly, the light-emitting parts 140 provided to correspond to the functions are restrained from turning on the display parts of other functions and independently turn on the display of functions. On the other hand, a sensor 240 that detects a selected position in accordance with the rotation of the knob 400 may be disposed on the mounting member 200 or the rotary knob 400.

The sensor 240 can detect the rotational position of the rotary knob 400 so that the driver may select a desired function while rotating the rotary knob 400. The sensor 240 may be implemented by various ways such as a pattern sensor, a photodiode, or a potentiometer and this technology is well known in the art, so the detailed description is not provided.

As described above, since the rotational position of the rotary knob 400 may be detected by the sensor 240 mounted on the mounting member 200 or the rotary knob 400, the driver can select a desired function from the switch device of the present invention. On the other hand, a position display unit 440 rotating with the rotation of the rotary knob 400 may be formed at the upper surface of the rotary knob 400.

Further, the position display unit 440 may be implemented by a light-emitting device that lights a position selected in accordance with the rotation of the rotary knob 400. The display unit 440 is disposed at the upper end of the rotary knob 400 and lights the rotational position while rotating with the rotation of the rotary knob 400. The light-emitting device is energized through a rotator mounted on the rotary knob and a contactor receiving power through the circuit board 100, so that the light-emitting device may receive electric power and emit light even through the rotary knob 400 is being rotated.

The position display unit 440 is implemented by a ring-shaped “mood” light enclosing the upper circumference of the rotary knob 400 and a light-emitting means that emits light in the mood light in accordance with the rotational position of the rotary knob 400, so it is possible to improve marketability and ensure visibility for the driver.

On the other hand, a support portion 260 facing the lower end of the rotary knob 400 is formed on the outer circumference of the mounting member 200, so that the push button 300 and the rotary knob 400 may be restrained from moving downward beyond a certain point.

When the push button 300 and the rotary knob 400 are moved down excessively by an excessive operation of the driver, the switch 120 on the circuit board 100 may be damaged or the push button 300 and the rotary knob 400 may become separated from the mounting member 200. In order to solve the problem, it is preferable to form a support portion 260 at the position facing the lower end of the rotary knob 400, on the mounting member 200 in order to restrain the push button 300 and the rotary knob 400 from moving down excessively (i.e. beyond a certain point).

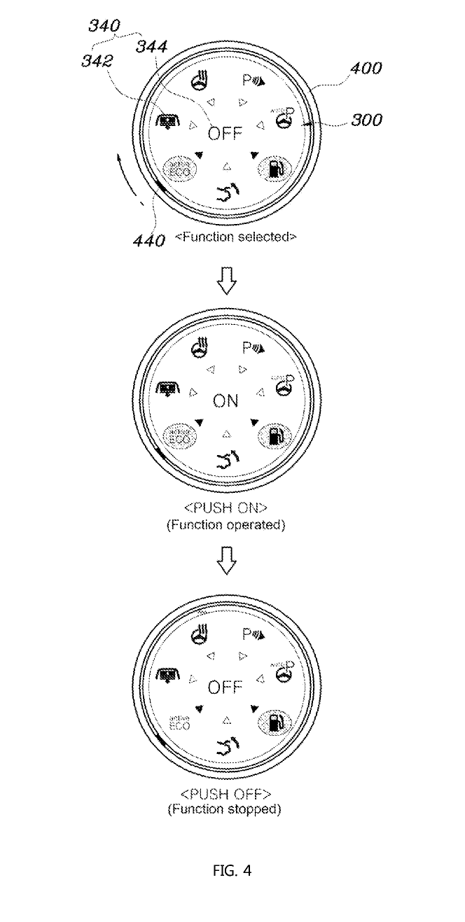

FIG. 4 is a view showing the operation of the switch device of the present invention, and according to the present invention, when the push button 300 is pushed after selecting a desired function by rotating the rotary knob 400, corresponding function is performed, thereby the work indicator 344 is turned on and the corresponding function in the function indicators 342 will be lighted. Further, when a driver wants to stop another function, the driver pushes the push button 300 after selecting the function by rotating the rotary knob 400 in the same way, and accordingly, the corresponding function is stopped, the indicator of the corresponding function in work indicators 342 is turned on, and the driver recognizes that the function is stopped. Through this operation, a desired function is selectively performed with a simple operation by rotating the rotary knob 400 or pushing the push button 300, in various functions provided in the vehicle, thereby providing convenience for the driver.

According to the switch device having the structure described above, it is possible to reduce the space required for mounting a switch due to its reduced size, by implementing the push button, the rotary knob, and the function display window in one operation switch, and it is possible to provide convenience for the driver by allowing various functions to be selectively performed with a simple operation of pushing after selecting the functions by rotating the rotary knob while still providing a cost efficient solution.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A switch device comprising:
a circuit board with a switch;
a mounting member fixed on the circuit board and having a vertical slit;
a push button inserted in the mounting member, vertically guided along the slit, pressing the switch when moved downward, and having a guide groove along the outer circumference thereof; and
a rotary knob enclosing the outer circumference of the push button, having a locking portion on an inner side which is inserted in the guide groove, rotating independently from the push button, and vertically moving while the push button is vertically moving.

2. The apparatus of claim 1, wherein a display unit formed on a top surface of the push button and is configured to display a plurality of functions and whether an operation is being performed.

3. The apparatus of claim 2, wherein a plurality of light-emitting parts corresponding to display of functions of the display unit is formed on the circuit board.

4. The apparatus of claim 2, wherein the push button is a hollow part and a plurality of separations vertically formed and dividing portions showing the functions of the display unit are formed in the push button.

5. The apparatus of claim 1, wherein a sensor is configured to detect a selected position in accordance with the rotation of the knob and is disposed on the mounting member or the rotary knob.

6. The apparatus of claim 1, wherein a position display unit rotating with the rotation of the rotary knob is formed at an upper end of the rotary knob.

7. The apparatus of claim 6, wherein the position display unit is implemented by a light-emitting device that lights a position selected in accordance with the rotation of the rotary knob.

8. The apparatus of claim 1, wherein a support portion facing a lower end of the rotary knob is formed on the outer circumference of the mounting member, so that the push button and the rotary knob are restrained from moving beyond a certain point.
